(19) United States
(12) Patent Application Publication
(10) Pub. No.: US 2004/0215519 A1
(43) Pub. Date: Oct. 28, 2004

(54) Inventory reconciliation

(76) Inventors: Bradley Shick, Cumming, GA (US); Jeffery O. Burrell, Atlanta, GA (US); Carol Brechtel, Baton Rouge, LA (US)

Correspondence Address: THOMAS, KAYDEN, HORSTEMEYER & RISLEY, LLP/, BELLSOUTH I.P. CORP, 100 GALLERIA PARKWAY, SUITE 1750, ATLANTA, GA, 30339, US

(21) Appl. No.: 10/424,884

(22) Filed: Apr. 28, 2003

(51) Int. Cl. G06F 17/60

(52) U.S. Cl. 705/15

(57) ABSTRACT

Inventory reconciliation systems are provided. A representative system, among others, includes a processing logic to analyze a plurality of records, reject logic responsive to the processing logic, operable to reject an action taken on a record by an inventory management system, and accept logic responsive to the processing logic, operable to accept an action taken on a record by the inventory management system. Methods and other systems for network resource management are also provided.

### FIELD OF THE INVENTION

The present invention is generally related to inventory tracking and more particularly to reconciliation of inventory discrepancies.

### DESCRIPTION OF THE RELATED ART

Businesses are often the subject of detailed regulatory requirements. For example, the Securities and Exchange Commission (SEC) requires public companies to keep detailed accounting in accordance with generally accepted accounting principles (GAAP), and the both Federal Communications Commission (FCC) and SEC require many telecommunications companies to keep asset record verifications (ARV), a detailed inventory of their assets. Additionally, businesses pay taxes on their assets, and thus want to keep an accurate record of the assets they own. For these and other reasons, it can be important to closely track inventory.

A problem with tracking inventory arises among large companies with lots of assets. These companies often contract with outside companies to perform the physical inventory. The physical inventory is typically done using hand-held scanners to read barcodes placed on the assets owned by the company. In the telecommunications business, the FCC requires businesses to keep track of specific classes of items of a larger group commonly referred to as central office plug-ins (sometimes referred to as plugs). Sometimes these plug-ins are too small to fit a barcode or any identifying markings, or sometimes the plug-ins cannot be accessed to include in the physical inventory. Thus, plug-ins for which a business has a record might not show up and sometimes plug-ins for which there is no record might appear.

Typically former Bell operating companies use a software solution called Plug-in Inventory Control System/Detailed Continuing Property Record (PICS/DCPR) program, available from Telcordia Technologies of Morristown, N.J., to resolve these inconsistencies. PICS/DCPR is an old software application designed to run on a mainframe computer. Because of its design and its age, it can be difficult to use and understand the display. Moreover, the data is typically not organized well for efficient consumption. Sample screen shots of the PICS/DCPR mainframe display can be seen in FIGS. 1A, 1B and 1C. PICS/DCPR uses a reverse retirement to handle plug-ins that were not present on previous inventories, or retires plug-ins that were present on previous inventories but missing on the current inventory. However, this is not necessarily the best way to handle all of the inventory discrepancies. Moreover, as stated before the PICS/DCPR screens are difficult to decipher.

Another software solution used is Alden Recon Wizard, available from Alden Systems, of Birmingham, Ala. The Recon Wizard sorts the data from PICS/DCPR and formats the data such that a user can more easily view the inconsistencies found.

After the Recon Wizard has formatted the data, several people are typically required to review the data and determine if the correct treatment was given to the records by PICS/DCPR. However, such reviewing is often tedious and produces inconsistent results. Thus, there is a need for systems that overcome the above shortcomings.

### SUMMARY OF THE INVENTION

One preferred embodiment, among others, of the present invention provides for an inventory reconciliation system. A representative system, among others, includes retirement logic operable to determine whether at least one item within the plurality of records was properly retired, reverse retirement logic operable to determine whether at least one item within the plurality of records was properly reverse retired, reject logic operable to add back items that were not properly retired and remove items that were not properly reverse retired and mark the record as rejected, and accept logic operable to mark records as accepted upon the retirement logic or the reverse retirement logic determining that the record was properly treated.

Another preferred embodiment of the present invention provides methods for inventory reconciliation. A representative method, among others, can include the following steps: retrieving a record containing information about a previous inventory and a current inventory; determining whether the record contains a retirement of any of at least one item associated with the record; adding at least one retired item back into the record if the retirement is an improper treatment of said at least one item; determining whether the record contains a reverse retirement of any of said at least one item associated with the record; and, removing at least one reverse retired item from the record if the reverse retirement is an improper treatment of said at least one item.

A further preferred embodiment of the present invention provides a computer readable medium having a program for inventory reconciliation. A representative program, among others, can perform the steps of: retrieving a record containing information about a previous inventory and a current inventory; determining whether the record from the previous inventory and current inventory match; accepting the record if the previous inventory and current inventory match; determining whether the record contains a retirement of any of at least one item in the record; determining whether the retirement of said at least one item is a proper treatment of the retired items; adding the retired item back into the record if the retirement is improper; determining whether the record contains a reverse retirement of any of said at least one item in the record; determining whether the reverse retirement of any of said at least one item is a proper treatment of the item; and, removing the reverse retired item from the record if the reverse retirement is improper.

### BRIEF DESCRIPTION OF THE DRAWINGS

Preferred embodiments of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1A is an illustration of a sample screen shot of the PICS/DCPR system.

FIG. 1B is an illustration of a second sample screen shot of the PICS/DCPR system.

FIG. 1C is an illustration of a third sample screen shot of the PICS/DCPR system.

FIG. 2 is a block diagram illustrating an embodiment, among others, of the operating environment of the preferred embodiments of the present invention.

FIG. 3 is a flowchart illustrating an embodiment, among others, of the inventory flow of the block diagram shown in FIG. 2.

FIG. 4 is a flowchart illustrating an embodiment, among others, of the reconciliation system used in conjunction with FIG. 2.

FIG. 5 is a flowchart illustrating an embodiment, among others, of a set of rules applied to determine whether a retirement from FIG. 4 is proper or improper.

FIG. 6 is a flowchart illustrating an embodiment, among others, of a set of rules applied to determine whether a reverse retirement from FIG. 4 is proper or improper.

FIG. 7A is an illustration of a first sample screen shot of an embodiment, among others, of the present invention.

FIG. 7B is an illustration of a second sample screen shot of an embodiment, among others, of the present invention.

FIG. 7C is an illustration of a third sample screen shot of an embodiment, among others, of the present invention.

### DETAILED DESCRIPTION OF THE PREFERRED EMBODIMENTS

The preferred embodiments of the present invention now will be described more fully with reference to the accompanying drawings. The invention may, however, be embodied in many different forms and should not be construed as limited to the embodiments set forth herein; rather, these embodiments are intended to convey the scope of the invention to those skilled in the art. Furthermore, all “examples” given herein are intended to be non-limiting.

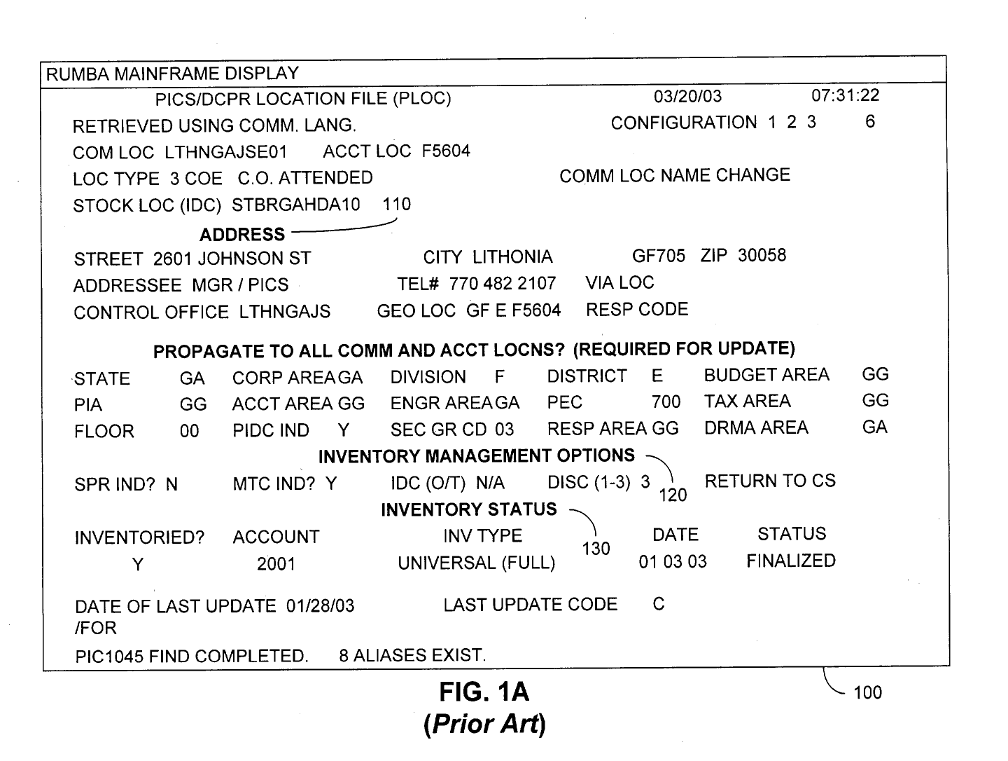

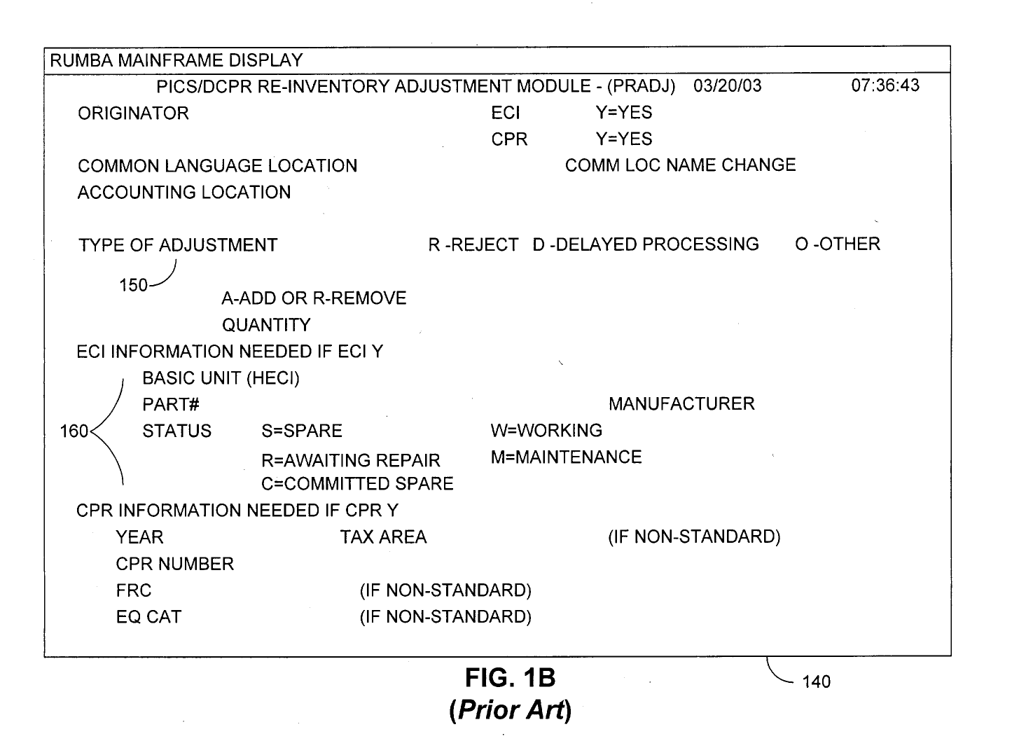

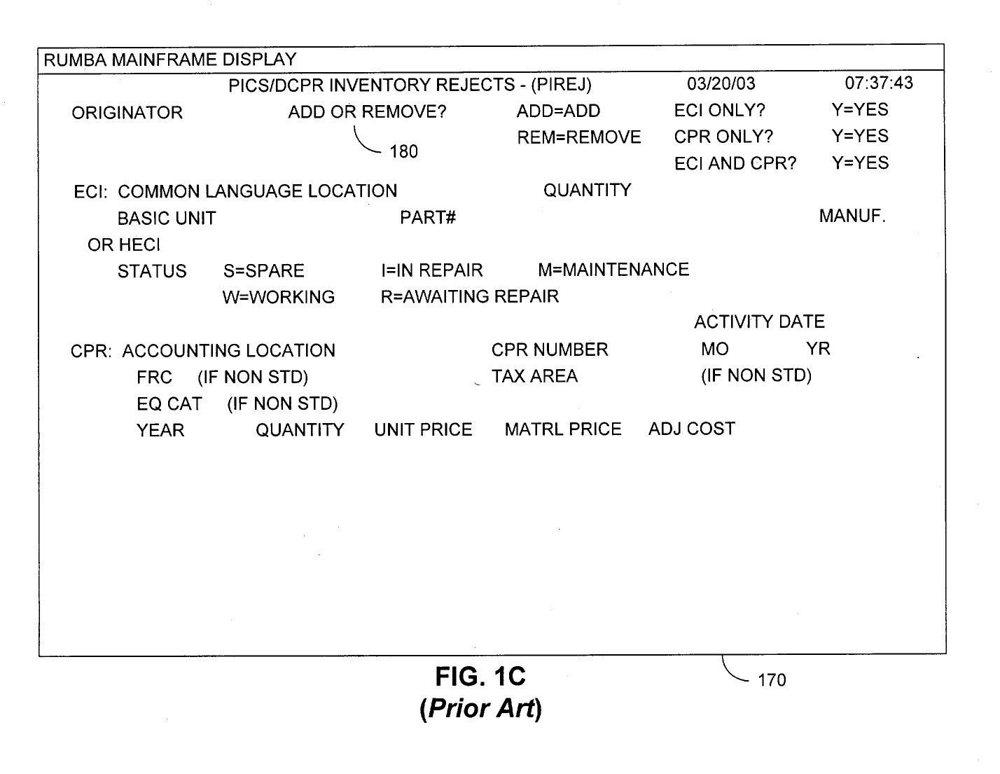

Referring now to FIGS. 1A, 1B and 1C shown are illustrations of a sample screen shots of the PICS/DCPR system. FIG. 1A shows a screen shot 100 of a location file indicating where the inventory took place. The location file shows the address 110 of the central office that was inventoried and allows the user to perform various management options 120 on the inventory, and the status 130 of the inventory. FIG. 1B shows a screen shot of a PICS/DCPR re-inventory adjustment screen 140, known in PICS/DCPR as a PRADJ. The PRADJ screen 140 allows the user to make adjustments to the inventory by specifying the type of adjustment 150 and information about the adjustment item 160. With respect to FIG. 1C, shown is a sample screen shot 170 for inventory rejects (PIREJ). Here the user can reject a change in the inventory by specifying to add or remove 180 an item from the inventory. It should be recognized by one skilled in the art that many more PICS/DCPR screens exist, and that these were shown merely for a better understanding of the present invention.

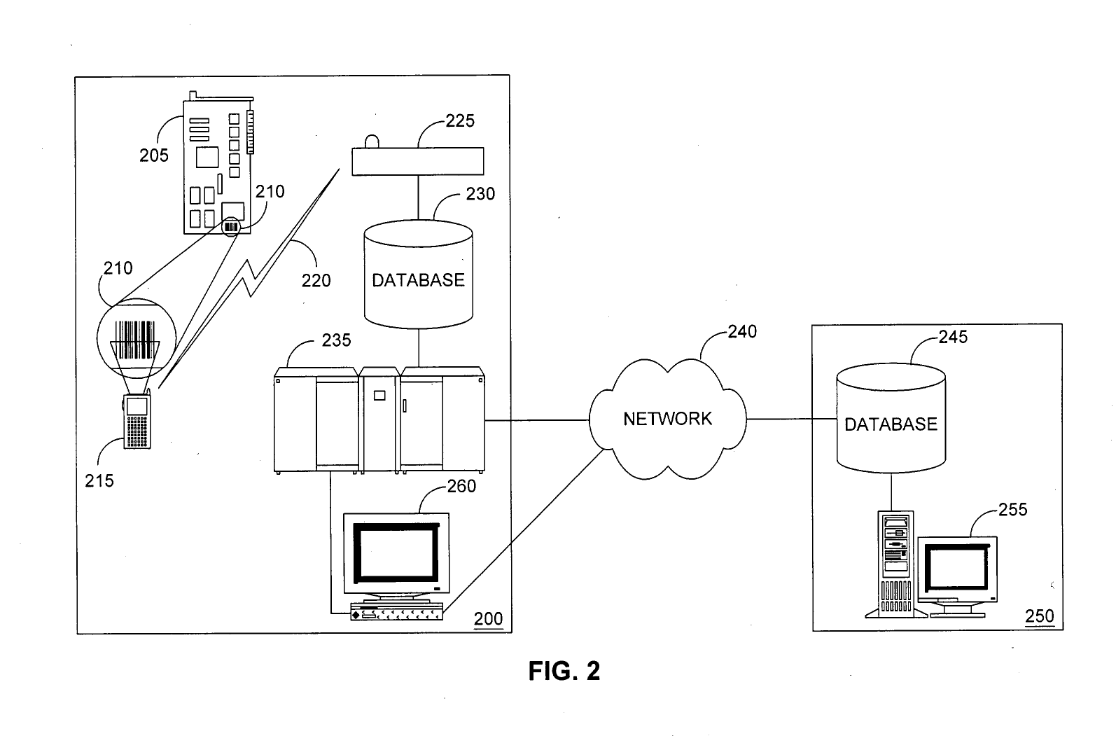

Referring now to FIG. 2, a block diagram is shown to illustrate an embodiment of a data collection system that can be used in conjunction with the present invention. Typically, a central office 200 contains a plurality of central office plug-ins, such as a computer card 205. These plug-ins can also include items such as routers, computers, etc. To increase efficiency in the inventory, the plug-ins are often given a barcode 210. These barcodes 210 can be scanned with a handheld scanner 215, and are typically based on a ten-digit number that uniquely identifies the part. This ten-digit number is commonly referred to as a Human Equipment Catalog Item (HECI) number in the telecommunications industry.

The scanner 215 typically uses a wireless connection 220 to a base station 225. The base station 225, in turn, is wired to a storage device 230 which stores the information received from the base station 225. The storage device 230 is connected to a mainframe 235 where the information that is collected via the handheld scanner 215 can be run through a PICS/DCPR program from Telcordia. The PICS/DCPR program compares the current inventory results with previous inventory results and changes the record when inconsistencies are found.

After PICS/DCPR creates an initial report, the data can be uploaded through a network 240 to a database 245 at an off-site location 250. The data can then be processed and formatted by an off-site computer 255 with a Recon Wizard program available from Alden Technologies. The Recon Wizard formats the PICS/DCPR data such that it is easier to read, more manageable and provides users with suggestions on identifying and dealing with particular pieces of equipment. Once the Recon Wizard report is finished, the report is sent to a central holding location on Alden's server, where it can be viewed with a computer 260 in an easy to read format.

A reviewer then typically reviews the records and marks the records for action based upon guidance from the Recon Wizard, or upon his or her interpretation of the record. However, the Recon Wizard still leaves about 1600 records, for example, in one implementation, to review manually, which would take a substantial amount of time. Moreover, each reviewer may happen to apply different treatment to the records even when nominally applying a uniform set of rules. Finally, after each of the records is marked for action, the Recon Wizard interacts with the PICS/DCPR program to adjust the records according to the action indicated by the reviewer.

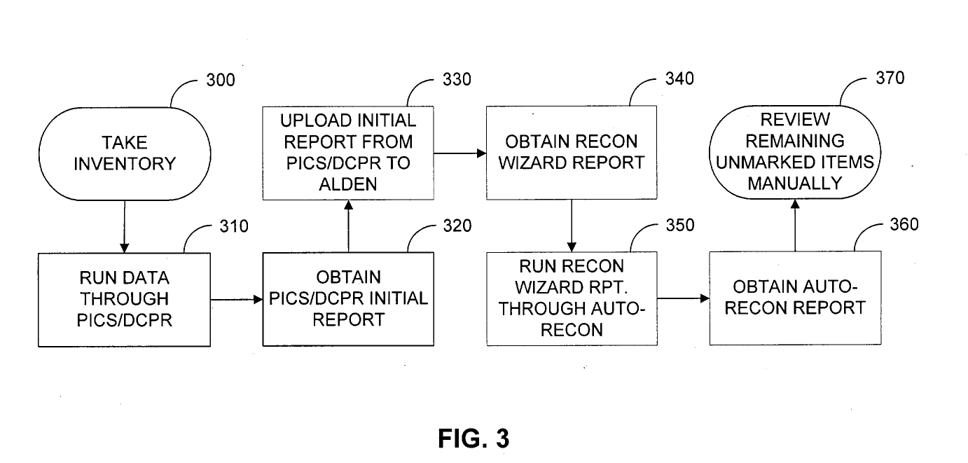

Referring now to FIG. 3, shown is a block diagram illustrating a flowchart of a process performed by the preferred embodiments of the present invention. In the first step 300, the inventory is taken using handheld bar code scanners 215. The scanners 215 typically have a wireless connection 220 to a base station 225 which is connected to a storage device 230 unit which can collect the information gathered by the wireless scanners 215. In the next step 310, the data is run through a PICS/DCPR program on a mainframe 235. In the next step 320, an initial report is obtained from the PICS/DCPR program.

Once the initial report is obtained, in the next step 330, the PICS/DCPR initial report is uploaded to Alden. At Alden, the Recon Wizard rearranges and formats the initial report obtained from PICS/DCPR, and a Recon Wizard report is developed in step 340. In accordance with an embodiment, among others, of the preferred embodiments of the present invention, in step 350, the Recon Wizard report is then used as input into a reconciliation system. The reconciliation system executes a series of rules on the Recon Wizard report. These rules are designed to have an objective basis for evaluating the data contained in the Recon Wizard report. Thus, there will be no inconsistencies in the data processed by the reconciliation system. The reconciliation system then modifies the Recon Wizard report to obtain a reconciliation system report in step 360. The reconciliation system report typically includes markings of the reconciled records which correspond to actions that have been performed on the PICS/DCPR inventory record by the reconciliation system. Typically, these actions are communicated to PICS/DCPR via Alden's Recon Wizard program which takes the marked records and communicates the changes to PICS/DCPR, however, one skilled in the art should recognize that other mechanisms for acting on the PICS/DCPR inventory record can be used in accordance with the present invention. Finally, in step 370, a reviewer takes the reconciliation system report and reviews any unmarked records manually to reconcile the remaining inconsistencies.

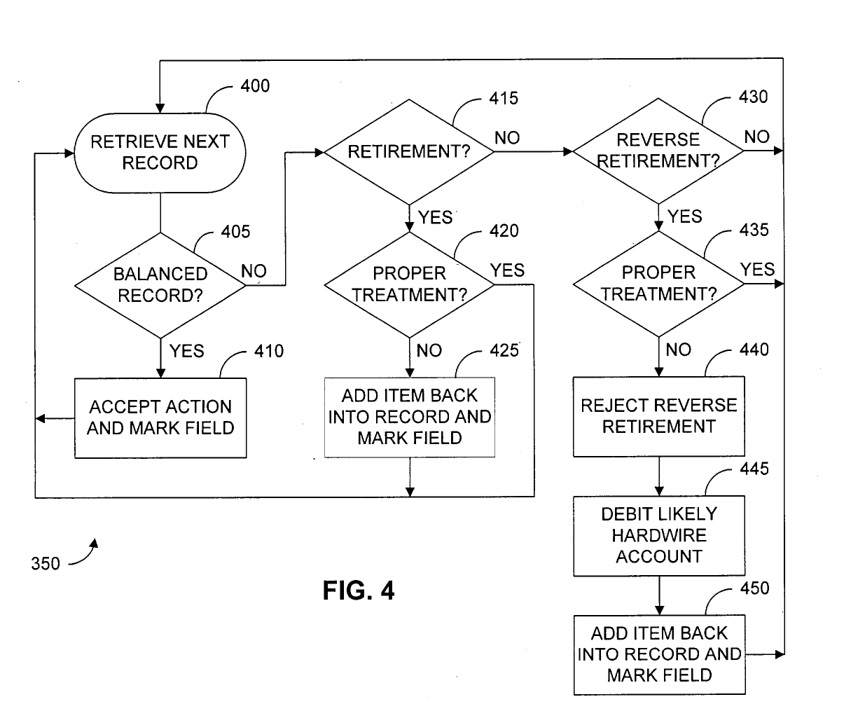

Referring now to FIG. 4, shown is an embodiment of a flowchart illustrating an embodiment, among others, of a method of evaluating the data input into the reconciliation system. In step 400, the system retrieves the next record to evaluate. In step 405, the reconciliation system evaluates whether the inventory for the record is matched. A matched record indicates that the number of units of a certain HECI number, and the number of units of that HECI number expected are the same. Since the record is matched, there is no need to review the record any further, and the record is marked accepted in step 410.

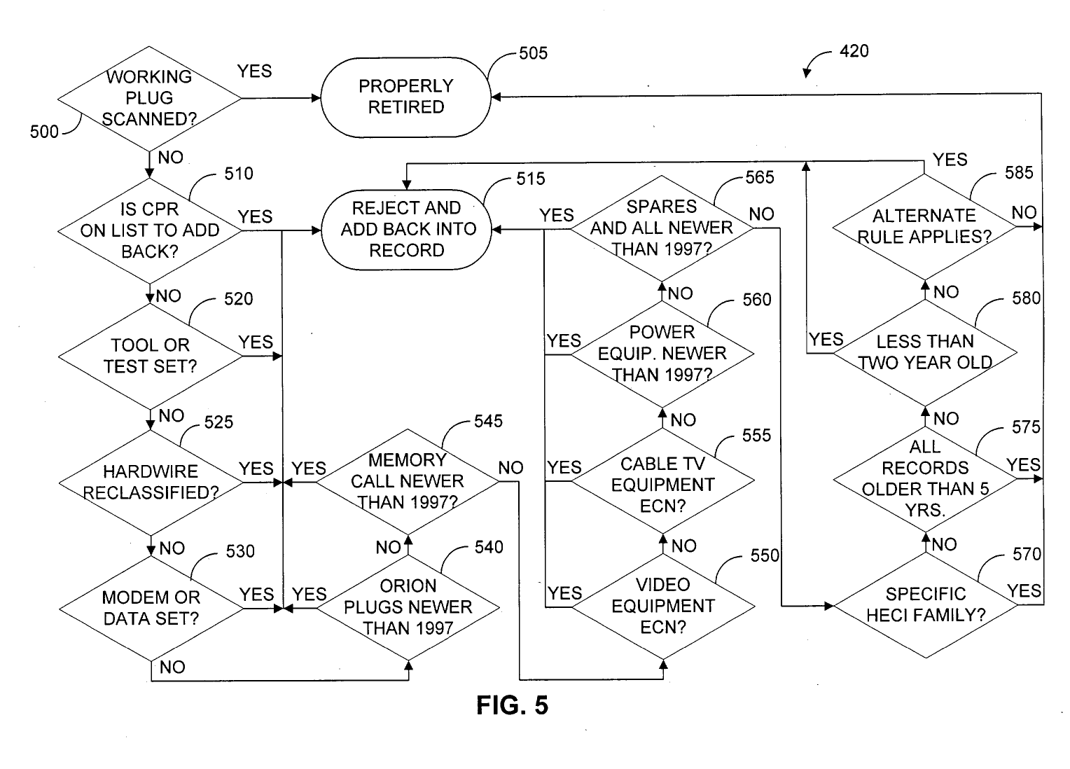

If the record is not matched, the record is analyzed further. For example, in one embodiment, the record is checked to determine whether it indicates a retirement of an asset in step 415. If the transaction was a retirement, the reconciliation system at step 420 checks the retirement to determine if retirement was the proper treatment of the asset (as discussed below with reference to FIG. 5). If retirement is not the proper treatment of the asset, the reconciliation system marks the record and adds the units back into the PICS/DCPR record in step 425. If retirement is the proper treatment of the record, the transaction is marked by the reconciliation system as accepted, and the reconciliation system returns to step 400 and retrieves another record.

In step 415, if it is determined that the transaction is not a retirement, the reconciliation system determines whether the transaction is a reverse retirement of an asset in step 430. A reverse retirement, in accounting terms, includes the discovery of an item that was not present in the previous accounting, but for whatever reason is present in the current accounting. As such, the reverse retirement typically adds value into the books under the asset side of a balance sheet, whereas a retirement removes value from the asset side of the balance sheet.

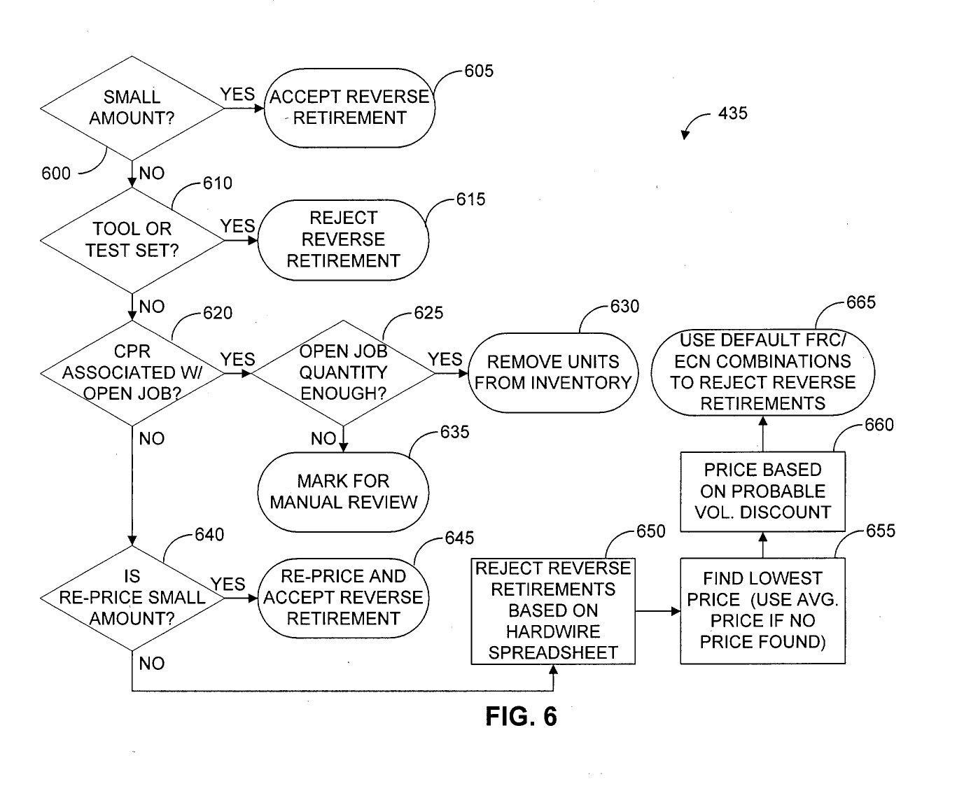

If the transaction is not a reverse retirement, the record is left unmarked for review manually and the system returns to step 400 to retrieve another record. Typically all records will be matched, retirements, or reverse retirements, so in some embodiments, among others, the reconciliation system could conclude that the record is a reverse retirement in step 430. If the transaction is a reverse retirement, the next step 435 is to determine whether reverse retirement was the proper treatment of the record (as discussed below with reference to FIG. 6). If the reverse retirement was the proper treatment of the record, the record is accepted and the next record is retrieved in accordance with step 400. If the reverse retirement was improper, the reconciliation system rejects the reverse retirement in accordance with step 440. The reconciliation system then finds a hardwire account that the extra item(s) is likely to have come from and debits the hardwire account based on a projected value of the extra item(s) in step 445. The reconciliation system, in preferred embodiments, among others, allows the user to specify a hardwire spreadsheet file to pull account information from. Typically the hardwire file can be stored on an internal network. The reconciliation system then extrapolates the expected age and value from the available data, and deducts this value from the corresponding vintage in the hardwire file. Finally, in step 450, the item is added back to the record and the field is marked. The reconciliation system then retrieves the next record in accordance with step 400. After there are no more records to retrieve, the reconciliation system ends having modified the original Recon Wizard file obtained from Alden.

Referring now to FIG. 5, shown is a flowchart illustrating one embodiment, among others, of a process used to determine whether retirement of an item was the correct treatment (as indicated in step 420 of FIG. 4). In step 500 the reconciliation system checks to determine whether the record contained a working plug-in that was scanned in the current inventory. The status of the plug-in as a working plug-in is typically determined by the person performing the inventory. If the record contained a working plug-in that was scanned, it is likely that the person doing the inventory knew how to find the particular plug-in, therefore the retirement is accepted in step 505.

If there was no working plug-in scanned, the reconciliation system proceeds to check whether a continuing property record (CPR) code associated with the items contained in the record for the plug-in is on a list to add back into the record in accordance with step 510. The CPR details the item recorded. The CPR codes which are exempted from retirement have been researched and determined to be difficult to find, difficult to scan, too small to have a barcode, etc. This list is typically stored and maintained inside the reconciliation system. A few such items that can be deemed difficult or impossible to find include: fiber build-outs, fuse and alarm circuit, alarm boards, telephone jack cards, fan fuse units, modem splitters, cooling fans, fiber converters and optical connectors. If the CPR code for the retirement is on the list of codes to add back into the record, the retirement is rejected in step 515. In step 520, the reconciliation system determines whether the retirement is for a tool or a test set. Tools and test sets are identified by an associated CPR range (X74, X76, X77, X78, and X79). Moreover these plug-ins are typically mobile, difficult to track, and are not a typical central office plug-in, so they are assumed to remain where originally located. As such, the retirement of a tool or test set is rejected in step 515.

In step 525, it is determined if the retirement was for hardwire equipment reclassified to be tracked by PICS. These are items that are technically classified as hardwire equipment, but are considered important to track by the company. Typically, this is determined according to the CPR identifier (N70, for example). If the retirement falls into this category, the retirement is rejected in accordance with step 515. In step 530, the reconciliation system determines whether the retirement is for a modem or data set. Modems and data sets have typically been found to be difficult to track, so these retirements are rejected and added back into the record in step 515. Again, this determination is made according to the CPR number associated with the retired plug-in.

In step 540, the reconciliation system determines whether the subject of the retirement is an Orion plug-in that is newer than 1997. The plug-in is typically determined to be newer than 1997 by examining the HECI number of the record. It has been determined that Orion plug-ins have a certain life expectancy, and plug-ins younger than this are not to be retired because it is more likely that they were missed during the inventory. If the reconciliation system determines that the retirement was for an Orion plug-in newer than 1997, then the retirement is rejected in step 515. Similarly, in step 545, the reconciliation system checks for X.25 plug-ins that are newer than 1997. Again the age of the plug-in is typically determined by examining the HECI number of the record. If the reconciliation system finds a record containing a retirement for such a plug-in the system rejects the retirement in step 515. The reconciliation system, in step 550, also checks for MemoryCall (equipment category number (ECN) 615XX) that are newer than 1997. If the record contains a retirement for the MemoryCall ECN newer than 1997, the reconciliation system rejects the retirement in step 515.

In step 555, the reconciliation system determines whether the record is for a retirement of video equipment where the ECN is 752XX. Video equipment is typically difficult for the person taking inventory to recognize because it has no labeling to identify it as a plug-in. Thus, in step 515, retirements for video equipment are rejected and added back into inventory. Similarly, the reconciliation system determines whether the retirement is for cable television equipment with an ECN of 450XX. If the retirement is for cable television equipment, the reconciliation system rejects the retirement in step 515.

In step 560, the reconciliation system determines whether the retirement is for power equipment (ECN 983XX or HECI PWXXXXX) where all records (not just those retired) are newer than 1997. Again, this is a determination that these plug-ins are relatively new and are likely not to have been retired so soon after their addition. Thus, the reconciliation system, in step 515, rejects the retirement of these items.

In step 565, the reconciliation system checks the record to determine whether the retirement was for an item that had only spares scanned, and all of the records are newer than 1997. Plug-ins where only spares are found and where the plug-ins are relatively new are not likely to be correctly retired, otherwise, there would probably be no spares. If there are only spares found, and all the plug-ins on record are newer than 1997, the reconciliation system rejects the retirement in step 515.

In step 570, the reconciliation system determines whether the retirement is for a specific HECI family, such as D4 units, DSL units, DDM units, FT-2000 units, FLM units, Litespan units and DISC*S units. These units are deemed typically easy to locate and scan, so in step 505, the reconciliation system accepts the retirement of these units.

In step 575, the reconciliation system checks the record to determine whether the plug-ins are older than 1998 and no plug-ins from the record were found. These plug-ins are deemed too old to investigate. Moreover, because none were found, it is likely that the use of these plug-ins has been discontinued. Thus, in step 505, the retirement is accepted if there were no plug-ins from the record scanned and all the plug-ins were older than 1998.

In step 580, the reconciliation system determines whether the record contains only items that were purchased in the past two years, for example. These items are considered so new that it is unlikely that they have already been retired. Thus, the reconciliation system rejects the retirement in step 515.

In step 585, the reconciliation system determines if there were no units scanned such that an alternative rule applies. These alternative rules can include: adding back records if an value associated with items subject to the retirement are in excess of a threshold amount and the records retired are newer than 1998; adding back retirements if all records are newer than 1998 and the units are worth more than another threshold amount; adding back retirements if all records are newer than 1998 and there are more than five unit remaining on record; and, accepting retirements that do not meet the other alternate rules and do not have a 2002 or 2003 record.

Referring now to FIG. 6, shown is a flowchart illustrating one embodiment, among others, of a process used to determine whether reverse retirement of an item was the correct treatment (as indicated in step 435 of FIG. 4). In step 600, the reconciliation system determines whether the amount involved in the reverse retirement is a small amount as determined by a threshold amount. Typically, adding a small amount into the asset column of the balance sheet does not have a large effect on the company, so it often is not worth the effort to resolve these transactions. In this particular embodiment, the threshold amount is defined by a total adjustment of less than $500 and unit cost less than $150. Thus, in step 605, the reconciliation system accepts the reverse retirement.

In step 610, the reconciliation system determines whether the subject of the reverse retirement is a tool or test set. As mentioned above, these items are typically mobile, difficult to track, and are not intended in this embodiment to be tracked as plug-ins. Therefore, the reconciliation system rejects the reverse retirement of these items in step 615.

In step 620, the reconciliation system determines whether the CPR of the record is identified with an open job in the Recon Wizard. An open job is typically associated with plug-ins that are currently in the process of being allocated to that central office location. When an open-job is closed, the PICS/DCPR program automatically updates the record. Thus, if the record is identified with an open job, the reconciliation system then determines whether the number of plug-ins on the open job is equal to or greater than the number of reverse retirements in the record, as shown in step 625. If the number of plug-ins shown on the open job is greater than or equal to the number of reverse retirements, it is likely that the new plug-ins are part of the open job, and should not be entered into the balance sheet. Therefore, in step 630, the reconciliation system rejects the reverse retirement and removes the units from the inventory. If the number of plug-ins on the open job is less than the number of plug-ins found, the reconciliation system marks the file for manual review in step 635.

In step 640, the reconciliation system determines whether the reverse retirement can be re-priced to a lesser amount. The re-price can be determined from a PICS/DCPR table showing the price of all plug-ins with respect to the vintage of the plug-in. If this re-price is below the threshold described with respect to step 600, the plug-in is re-priced and the reverse retirement is accepted in step 645.

However, if a re-price would not allow the reverse retirement to be accepted, in step 650 the reverse retirement is rejected, and assets are pulled from the hardwire sheet because this is likely the source of the reverse retirements. A hardwire sheet typically contains items that are not a part the current inventory, and are not defined as plug-ins, but are rather defined as hardwire equipment. However, the hardwire equipment can contain plug-ins that should be kept in the inventory of the central office plug-ins. In step 655, the reconciliation system then searches for the lowest price on the PICS/DCPR price table, pricing the plug-in at an average price ($383, for example) if no price is found on the table. Then, the reconciliation system adjusts the price based upon a probable volume discount in step 660. In this embodiment, if the adjustment is for less than 25 units: the price on the table is used if the price is less than $500; the price is divided by two if the price is between $500 and $2,499; the price is divided by four if the price is between $2,500 and $4,999; the price is divided by eight if the price is above $5,000. If the adjustment is for more than 25 units: the price is divided by two if the price is less than $500; the price is divided by four if the price is between $500 and $2,499; the price is divided by eight if the price is between $2,500 and $4,999; the price is divided by 16 if the price is above $5,000.

In step 665, the reconciliation system takes those records for which no field reporting code (FRC) or ECN was found in the hardwire spreadsheet, and reclassifies the FRC/ECN based on an FRC/ECN combination. The reclassification occurs because there are sometimes plug-ins that are typically classified in a certain FRC/ECN, but are actually being used in an alternative manner. Thus, there is a default list that shows combinations that can be substituted. These reverse retirements are rejected and then added back using the new FRC/ECN to debit the hardwire spreadsheet in accordance with the rejecting the reverse retirement. Any records that are left unmarked are left for manual review.

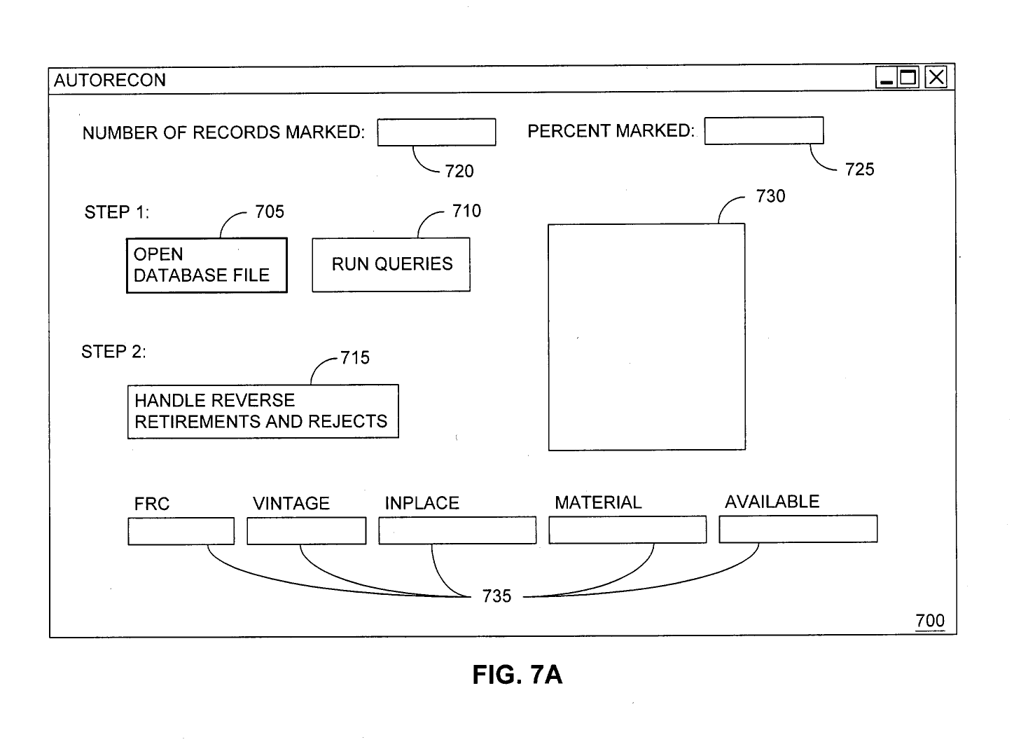

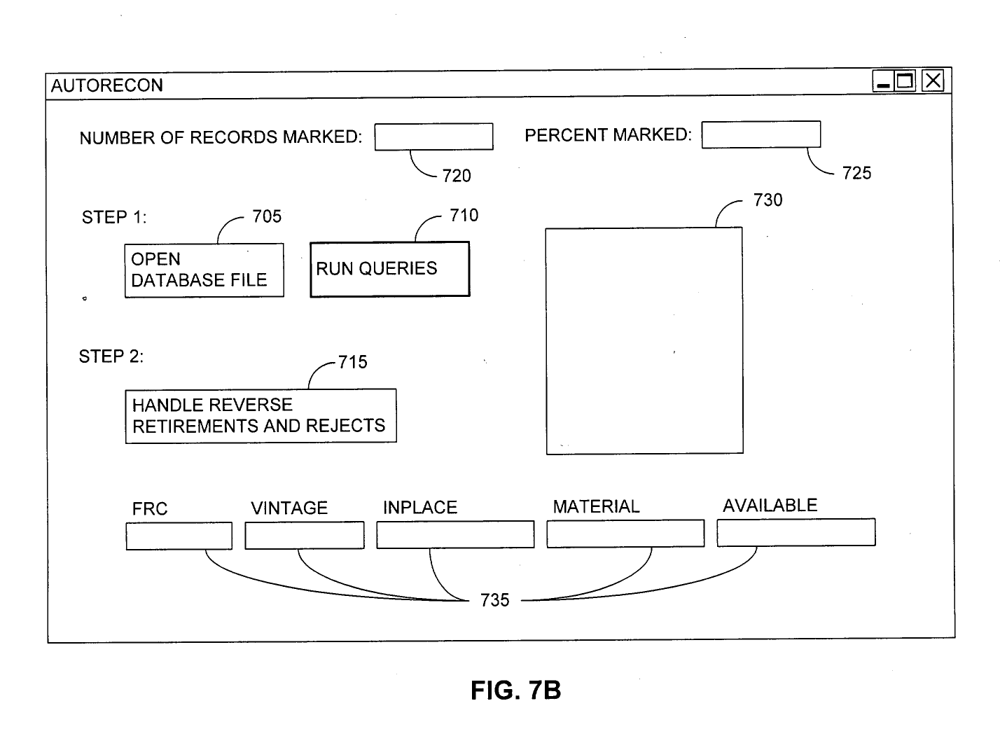

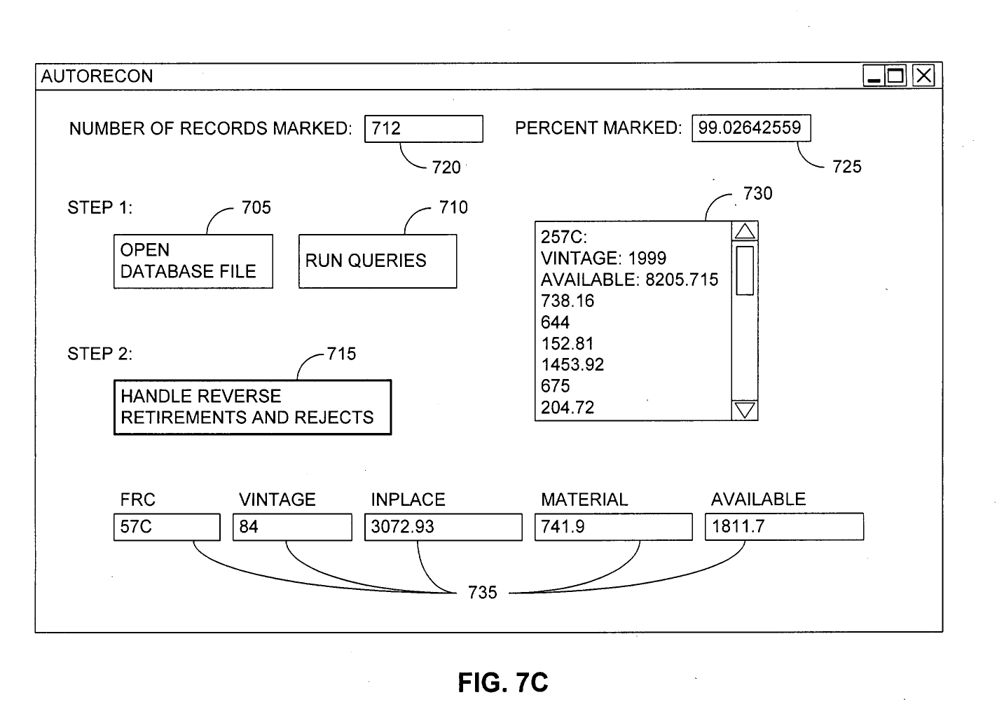

Referring now to FIGS. 7A, 7B and 7C, shown are sample screen shots of an embodiment, among others, of the present invention. In FIG. 7A, an embodiment, among others, of the initial screen 700 of the reconciliation system is shown. On this screen 700, a computer user can click the button representation 705 corresponding to “Open Database File.” Upon clicking on the button representation 705, the reconciliation system will retrieve a file browsing window, allowing the user to select a representation of a file that the user wishes to use as input for the reconciliation system. As one example, this file is typically the Recon Wizard file, which is an Access database file (Access is available from Microsoft of Redmond, Wash.). Upon the user selecting the file representation, the reconciliation system opens the file.

Referring now to FIG. 7B, after the reconciliation system opens the file, the user may then click the “Run Queries” button representation 710. Upon sensing that the “Run Queries” button representation has been selected, the reconciliation system will begin to implement the rules upon each of the records contained within the database file. The first process will check to determine whether every retirement record contained within the database file was properly retired by PICS/DCPR.

After completing this determination, the user will select the “Handle Reverse Retirements and Rejects” button representation 715. Upon sensing that the user has selected the “Handle Reverse Retirements and Rejects” button representation, the reconciliation system will provide a file browsing window which allows the user to open a hardwire account spreadsheet. The spreadsheet will be used by the reconciliation system to transfer figures from the hardwire account to the plug-in account in order to balance the books. During the retirement and reverse retirement processing the number of records marked field representation 720 and percent of records marked field representation 725 can be updated automatically by the reconciliation system. These representations indicate how many fields have been marked, and what percentage of the total number of fields have been marked, respectively.

Referring now to FIG. 7C, the user will select a hardwire spreadsheet for the reconciliation system to use in processing the reverse retirements that were not accepted by the reconciliation system. The hardwire spreadsheet is typically kept at a centralized location, and only accessed through the reconciliation system to debit hardwire accounts, and PICS/DCPR to add new value to the accounts. The hardwire adjustment field 730 can be used during the reverse retirement processing to view the activities performed by the reconciliation system. The first debit from the hardwire spreadsheet, in this example, was debited from the 257C FRC, the vintage is 1999, and the amount available in this vintage is 8205.715. Each number below the available amount is debited from the hardwire spreadsheet. The user can scroll through the hardwire adjustment field 730 and see every FRC adjusted in the current reconciliation. Under each FRC is located the vintage, beginning available amount, and each debit from the hardwire spreadsheet account for that FRC. Moreover, an embodiment of the present invention can include a number of current record fields 735, such that the user can view the record currently being processed and debited from the hardwire spreadsheet. These current record fields 735 can include the FRC, the vintage of the plug-in, the inplace cost (material plus tax, labor, etc.), the material cost (cost of the plug-in alone), and the amount available from the hardwire account, among others.

Process and function descriptions and blocks in flow charts can be understood as representing, in some embodiments, modules, segments, or portions of code which include one or more executable instructions for implementing specific logical functions or steps in the process, and alternate implementations are included within the scope of the preferred embodiment of the present invention in which functions may be executed out of order from that shown or discussed, including substantially concurrently or in reverse order, depending on the functionality involved, as would be understood by those reasonably skilled in the art of the present invention. In addition, such functional elements can be implemented as logic embodied in hardware, software, firmware, or a combination thereof, among others. In some embodiments involving software implementations, such software comprises an ordered listing of executable instructions for implementing logical functions and can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a computer-readable medium can be any means that can contain, store, communicate, propagate, or transport the software for use by or in connection with the instruction execution system, apparatus, or device.

It should be emphasized that the above-described embodiments of the present invention are merely possible examples of implementations set forth for a clear understanding of the principles of the invention. Many variations and modifications may be made to the above-described embodiment(s) of the invention without departing substantially from the principles of the invention. All such modifications and variations are intended to be included herein within the scope of this disclosure and the present invention and protected by the following claims.

What is claimed is:

1. A computer readable medium having a program for inventory control of a plurality of units, the program operable to perform the steps of:
retrieving a record containing information about a previous inventory and a current inventory;
determining whether the record from the previous inventory and current inventory match;
accepting the record responsive to a match in the previous inventory and current inventory; and
processing the record responsive to a mismatch of at least one item contained in the record.

2. The system of claim 1, wherein processing the record responsive to a mismatch of at least one item contained in the record comprises:
determining whether the record contains a retirement of any of at least one item in the record;
determining whether the retirement of said at least one item is a valid treatment of the retired items;
adding the retired item back into the record responsive to the retirement being invalid.

3. The program of claim 2, wherein the step of determining whether the retirement of said at least one item is valid comprises:
accepting the retirement responsive to determining that a working unit was found.

4. The program of claim 3, wherein the step of determining whether the retirement of said at least one item is valid comprises:
accepting the retirement responsive to finding that the record was associated with a specific human equipment catalog item family.

5. The program of claim 4, wherein the step of determining whether the retirement of said at least one item is valid comprises:
accepting the retirement responsive to finding that the all items associated with the record are older than a predetermined period of time.

6. The program of claim 5, wherein the predetermined period of time is five years.

7. The program of claim 2, wherein the step of determining whether the retirement of said at least one item is valid comprises:
rejecting the retirement responsive to the record including a continuing property record from a first list.

8. The program of claim 7, wherein the step of determining whether the retirement of said at least one item is valid comprises:
rejecting a retirement responsive to finding that the record was for a tool or a test set.

9. The program of claim 8, wherein the step of determining whether the retirement of said at least one item is valid comprises:
rejecting the retirement responsive to finding that the record was for a reclassified non-inventory item.

10. The program of claim 9, where the step of determining whether the retirement of said at least one item is valid comprises:
rejecting the retirement responsive to finding that the record was for a modem or data set.

11. The program of claim 10, wherein the step of determining whether the retirement of said at least one item is valid comprises:
rejecting the retirement responsive to finding that the retirement was for a MemoryCall unit less than a first predetermined age.

12. The program of claim 11, wherein the step of determining whether the retirement of said at least one item is valid comprises:
rejecting the retirement responsive to finding that the retirement was for Orion plug-ins less than the first predetermined age.

13. The program of claim 12, wherein the step of determining whether the retirement of said at least one item is valid comprises:
rejecting the retirement responsive to finding that the retirement was for difficult or impossible to track items.

14. The program of claim 13, wherein the step of determining whether the retirement of said at least one item is valid comprises:
rejecting the retirement responsive to finding that the retirement was for video equipment.

15. The program of claim 14, wherein the step of determining whether the retirement of said at least one item is valid comprises:
rejecting the retirement responsive to finding that the retirement was for cable television equipment.

16. The program of claim 15, wherein the step of determining whether the retirement of said at least one item is valid comprises:
rejecting the retirement responsive to finding that the retirement was for power equipment less than the first predetermined age.

17. The program of claim 16, wherein the step of determining whether the retirement of said at least one item is valid comprises:
rejecting the retirement responsive to finding that the retirement was for a record in which there was at least one spare scanned and all items in the record are less than the first predetermined age.

18. The program of claim 17, wherein the step of determining whether the retirement of said at least one item is valid comprises:
rejecting the retirement responsive to finding that the retirement items less than a second predetermined age.

19. The program of claim 18, wherein the step of determining whether the retirement of said at least one item is valid comprises:
rejecting the retirement responsive to finding that an alternate rule applied for the retirement.

20. The system of claim 1, wherein processing the record responsive to a mismatch of at least one item contained in the record comprises:
determining whether the record contains a reverse retirement of any of said at least one item in the record;
determining whether the reverse retirement of any of said at least one item is a valid treatment of the item; and
removing the reverse retired item from the record responsive to the reverse retirement being invalid.

21. The program of claim 20, wherein the step of determining whether the reverse retirement of said at least one item is valid comprises:
determining a value associated with said at least one item is below a threshold value; and
re-pricing said at least one item responsive to determining the value is below a threshold value; and
accepting the retirement of said at least one item responsive to the re-pricing of said at least one item.

22. The program of claim 21, wherein the step of determining whether the reverse retirement of said at least one item is valid comprises:
rejecting the retirement responsive to finding that said at least one item is a tool or test set.

23. The program of claim 22, wherein the step of determining whether the reverse retirement of said at least one item is valid comprises:
rejecting the retirement responsive to finding that said at least one item is associated with an open job.

24. The program of claim 23, wherein the step of determining whether the reverse retirement of said at least one item is valid comprises:
rejecting the retirement responsive to associating said at least one item with a non-inventory account with available funds.

25. An inventory reconciliation system for reconciling a plurality of records between inventories of a central office, the system comprising:
processing logic operable to analyze the plurality of records;
reject logic responsive to the processing logic, operable to reject an action taken on a record by an inventory management system; and
accept logic responsive to the processing logic, operable to accept an action taken on a record by the inventory management system.

26. The system of claim 25, wherein the processing logic comprises:
retirement logic operable to determine whether at least one item within the plurality of records was validly retired; and
reverse retirement logic operable to determine whether at least one item within the plurality of records was validly reverse retired.

27. The system of claim 26, wherein the reject logic is operable to add back items that were not validly retired and remove items that were not validly reverse retired and mark the record as rejected.

28. The system of claim 26, wherein the accept logic is operable to mark records as accepted upon the retirement logic or the reverse retirement logic determining that the action by the inventory management system was valid.

29. The system of claim 26, wherein the retirement logic further comprises:
a first logic operable to determine whether a working item from the record was scanned;
a second logic operable to determine whether all items in the record are older than five years; and
a third logic operable to determine whether the record belongs to a specific human equipment catalog item family.

30. The system of claim 26, wherein the retirement logic is operable to reject retirements of certain items less than a first predetermined age.

31. The system of claim 26, wherein the retirement logic is further operable to reject retirements of certain items regardless of age.

32. The system of claim 31, wherein the retirement logic is further operable to signal the reject logic responsive to finding retirements of items that are less than a second predetermined age.

33. The system of claim 32, wherein the retirement logic is further operable to signal the reject logic responsive to finding retirements which exceed a threshold value.

34. The system of claim 26, wherein the reverse retirement logic further comprises:
re-price logic operable to re-price at least one item associated with the record, such that the reverse retirement is valid.

35. The system of claim 34, wherein the reverse retirement logic is operable to signal the accept logic when the reverse retirement is below a threshold value.

36. The system of claim 35, wherein the reverse retirement logic is operable to signal the reject logic responsive to finding tools or test sets.

37. The system of claim 36, wherein the reverse retirement logic is operable to signal the reject logic when the additional units are associated with an open job.

38. The system of claim 37, wherein the reverse retirement logic is operable to signal the reject logic responsive to value being available from a probable vintage on a hardwire spreadsheet associated with the central office.

39. The system of claim 38, wherein the reverse retirement logic further comprises logic operable to re-price the reverse retirement, apply a volume discount, and debit a hardwire account.

40. The system of claim 39, wherein the reverse retirement logic is operable to determine whether an item is being used differently than shown by a field reporting code associated with the item.

41. A method of reconciling inventory, comprising the steps of:
retrieving a record containing information about a previous inventory and a current inventory;
determining whether the record contains a retirement of any of at least one item associated with the record;
adding at least one retired item back into the record responsive to finding the retirement is an invalid treatment of said at least one item;
determining whether the record contains a reverse retirement of any of said at least one item associated with the record; and
removing at least one reverse retired item from the record responsive to the reverse retirement being an invalid treatment of said at least one item.

42. The method of claim 41, wherein the method further comprises:
accepting the record responsive to the previous inventory and current inventory matching.

43. The method of claim 41, wherein adding at least one retired item back into the record responsive to the retirement being an invalid treatment of said at least one item comprises:
retiring said at least one retired item responsive to there being a working item found in the record.

44. The method of claim 43, wherein adding the retired item back into the record responsive to the retirement being an invalid treatment of said at least one item comprises:
retiring said at least one retired item responsive to said at least one retired item being in a specified human equipment catalog interface family.

45. The method of claim 44, wherein adding at least one retired item back into the record responsive to the retirement being an invalid treatment of said at least one item comprises:
retiring said at least one retired item responsive to all items in the record being more than five years old.

46. The method of claim 41, wherein adding at least one retired item back into the record responsive to the retirement being an invalid treatment of said at least one item comprises:
rejecting the retirement of said at least one item responsive to it being in a specific category of items.

47. The method of claim 46, wherein adding at least one retired item back into the record responsive to the retirement being an invalid treatment of said at least one item comprises:
rejecting the retirement of said at least one item responsive to it being in a specific category of items and is less than a first predetermined age.

48. The method of claim 47, wherein adding at least one retired item back into the record responsive to the retirement being an invalid treatment of said at least one item comprises:
rejecting the retirement of said at least one item responsive to the item being less than two years old.

49. The method of claim 48, wherein adding at least one retired item back into the record responsive to the retirement being an invalid treatment of said at least one item comprises:
rejecting the retirement of said at least one item responsive to the retirement being in excess of a threshold value.

50. The method of claim 41, wherein removing at least one reverse retired item from the record responsive to the reverse retirement being an invalid treatment of said at least one item comprises:
accepting the reverse retirement of said at least one item responsive to a value associated with said at least one item being below a threshold value or can be re-priced to a value below said threshold value.

51. The method of claim 50, wherein removing at least one reverse retired item from the record responsive to the reverse retirement being an invalid treatment of said at least one item comprises:
rejecting the reverse retirement of said at least one item responsive to it being a part of a tool or test set.

52. The method of claim 51, wherein removing at least one reverse retired item from the record responsive to the reverse retirement being an invalid treatment of said at least one item comprises:
rejecting the reverse retirement of said at least one item responsive to said at least one item being associated with an open job; and
marking the record for manual review responsive to said at least one retired item having a greater quantity of items than are associated with an open job .

53. The method of claim 52, wherein removing at least one reverse retired item from the record responsive to the reverse retirement being an invalid treatment of said at least one item comprises:
rejecting the reverse retirement of said at least one item based upon a hardwire account availability.

54. The method of claim 53, wherein removing at least one reverse retired item from the record responsive to the reverse retirement being an invalid treatment of said at least one item comprises:
rejecting the reverse retirement of said at least one item based upon a hardwire account availability for a first field reporting code associated with said at least one item.

55. The method of claim 54, wherein rejecting the reverse retirement of said at least one item based upon a hardwire account availability comprises:
using a second field reporting code to determine the hardwire account availability upon determining that said at least one item is being used for a different function than indicated by the first field reporting code.
